(19) United States
(12) Patent Application Publication
(10) Pub. No.: US 2026/0364926 A1
(43) Pub. Date: Nov. 19, 2026

(54) DECORATIVE PANEL AND METHOD FOR MANUFACTURING SUCH PANEL

(71) Applicant: UNILIN, BV, Wielsbeke (BE)

(72) Inventors: Benny SCHACHT, Wielsbeke (BE); Wim SPRIET, Wielsbeke (BE); Martin SEGAERT, Wielsbeke (BE)

(21) Appl. No.: 19/137,066

(22) PCT Filed: Dec. 13, 2023
(86) PCT No.: PCT/IB2023/062608

§ 371 Date: Jun. 9, 2025

Related U.S. Application Data
(63) Continuation of application No. PCT/IB2023/060283, filed on Oct. 12, 2023.
(60) Provisional application No. 63/491,541, filed on Mar. 22, 2023.
(60) Provisional application No. 63/491,962, filed on Mar. 24, 2023.

(30) Foreign Application Priority Data
Dec. 14, 2022 (EP) 22213577.4

(51) Int. Cl. B32B 27/06; B32B 27/30; E04F 15/10

(52) U.S. Cl. CPC B32B 27/065; B32B 27/308; E04F 15/107; B32B 2266/0235; B32B 2266/025; B32B 2307/4023; B32B 2307/7376; B32B 2419/04

(57) ABSTRACT

A decorative panel includes at least a substrate and a decorative top layer. The substrate is or includes a board material that has one or more layers of thermoplastic material, and the decorative top layer includes a decorative print. An intermediate layer is located between the surface of the outermost layer of the substrate or board material and the decorative print. This intermediate layer is based on and/or is essentially made of glycidyl methacrylate (GMA), glycidyl methyl methacrylate (GMMA), or copolymers. The outermost layer of the board material may be foamed and/or filled with hollow filler materials. A method is provided for manufacturing such a decorative panel.

The present invention relates to decorative panels, such as floor panels, and to a method ideally suited for manufacturing such decorative panels.

In particular, the invention relates to decorative panels comprising a substrate and a decorative top layer applied thereon. Such decorative panels, more particularly floor panels, are well-known now and form an alternative for natural floor products, such as solid parquet flooring and natural stone. The decorative top layer may be printed with a pattern of wood or stone, or may comprise a layer of wood or stone. Examples of such floor panels are known, for example, from WO 97/47834, EP 1 038 689, EP 1 875 011, WO 2017/087725, WO 2011/141849, WO 2018/087637 and WO 2018/087638.

Laminate panels, as known from WO 97/47834, contain a substrate of MDF or HDF (Medium or High Density Fiberboard). Such substrate material cannot cope with prolonged exposure to moisture. In order to remedy this, WO 2017/087725 and WO 2017/133804 propose floor panels comprising a filled thermoplastic substrate. The substrate material of these floor panels is waterproof and may be provided with mechanical coupling parts in order to make a smooth floating installation possible. The substrate material may have a limited thickness, for example 5 millimeters or less, and is produced with a high density. The high density, for example close to 2000 kg/m³, contributes to the stability of the floor covering. However, a packaging unit containing five panels or more may result in ergonomic problems during handling. Likewise, transportation via the road or in containers is not optimal.

WO 2020/161609 discloses providing internal spaces or excavations at the bottom of the substrate, in order to make panels with a filled thermoplastic substrate material or a mineral substrate material lighter. Although effective for weight reduction, the use of such internal spaces or excavations may require an altered composition for the thermoplastic substrate material in order to prevent undesirable cupping, warping and telegraphy of the spaces and excavations to become discernible on the decorative top layer. The technique from the WO'609 further requires an adaptation of the delicate extrusion operation. Further, consumers generally do not appreciate spaces or excavations that have the single purpose of making the panels lighter, or less expensive. A connotation of a lack of quality may be linked to such spaces.

WO 2011/141849 proposes the use of a foamed substrate material having denser outer layers, and an additional back layer of a vinyl compound applied to the top side of the substrate. Such floor panel requires additional conversion steps, and the denser outer layers, together with the relatively thick additional back layer may again increase the weight of the floor panel.

The prime object of the present invention is to provide an alternative decorative panel, wherein, in accordance with various preferred embodiments, a solution is offered for one or more of the problems associated with the prior-art floor panels.

To this end, the invention, according to its first independent aspect is a decorative panel comprising at least a substrate and a decorative top layer, wherein said substrate is or comprises an extruded board material comprising one or more layers of thermoplastic material and wherein said decorative top layer at least comprises a decorative print, with as a characteristic that an outermost layer of said extruded board material is foamed and/or filled with hollow filler materials, and in that an intermediate layer, preferably a bridging layer, is present intermediate the surface of said outermost layer and said decorative print.

It is clear that according to the invention that at least said outermost layer is foamed, and that it is not excluded that one or more other portions of the extruded board material may be foamed. The substrate may for example comprise or consist of a single layer of extruded and foamed thermoplastic material.

Preferably, said decorative panel consists of said extruded board material, said intermediate layer, said decorative top layer, and optionally a foam layer glued to the bottom of said extruded board material.

Said intermediate layer preferably at least bridges one or more, and preferably all or substantially all, open cells and/or hollow filling materials available at the outer surface of said outermost layer, and thus forms a bridging layer. Alternatively, or in combination, said intermediate layer may enter or even fill one or more, and preferably all or substantially all, open cells and/or hollow filling materials available at the outer surface of said outermost layer.

Preferably, the surface of said intermediate layer that is facing away from said outermost layer extends over one or more, and preferably all, open cells and/or hollow filling materials available at said surface of said outermost layer, preferably in a planar manner, i.e. the surface of said intermediate layer at least at the location of the respective cells and/or filling materials extends in a planar manner. Preferably, said surface is planar over substantially the entire outer surface of said outermost layer, potentially with the exceptions of embossments provided in said decorative layer and extending into said intermediate layer.

It is hence clear that the surface of said intermediate layer that faces away from the substrate may follow the contour of one or more embossments in said decorative top layer, while preferably extending planarly over one or more excavations and/or hollow portions in the surface of said outermost layer of said substrate. It is clear that such hollow portions may be formed by hollow filling materials available at said surface of said outermost layer and/or by closed and/or open cells available directly adjacent to, respectively at said surface of said outermost layer.

As stated above, it is possible that said outermost surface comprises excavations, wherein the surface of said intermediate layer that faces away from said outermost surface is more planar, or is preferably substantially level.

The intermediate layer that is applied in accordance with the invention may provide an enhanced lamination strength of the decorative print, more particularly of a decorative layer comprising said decorative print. Further the intermediate layer may provide for an enhanced production process, as it may provide for a more level surface to provide said decorative print or decorative layer. As the intermediate layer may bridge or fill one or more hollow portions available at or directly adjacent to the surface of said outermost layer, it may provide for an enhanced indentation resistance, and a minimization of squeaking noises originating from breaking cell walls or breaking hollow filling materials. By so doing a serviceable decorative panel, more particularly floor panel, may be obtained on the basis of an extruded substrate material of limited weight.

According to the most preferred embodiment, said decorative print comprises inks provided on a thermoplastic foil, wherein said intermediate layer is present intermediate the surface of said outermost layer and said thermoplastic foil. Preferably, said intermediate layer is directly adjacent to said thermoplastic foil. Alternatively, said intermediate layer is separated from said thermoplastic foil exclusively by means of a glue layer, i.e. a layer forming an adhesive bound between said thermoplastic foil and said intermediate layer.

In said most preferred embodiment, said intermediate layer is preferably based on a thermoplastic material different from the material of said thermoplastic foil and/or the extruded substrate material. Such differences may be one or a combination of two or more of multiple possibilities, of which here below some possible differences are listed.

According to a first possibility, said intermediate layer is based on a thermoplastic material having a lower glass transition temperature than the material of said thermoplastic foil and/or has a glass transition temperature of 50 °C or less, preferably of below 23 °C, even better below 0 °C, without necessarily being different from the material of the thermoplastic foil and/or the extruded substrate material. In such case the intermediate layer can deform at low temperature, even, as the case may be, at lower temperatures than said thermoplastic foil and/or the extruded substrate material, and can be made to at least partially fill or conform to unevenesses in the outer surface of said outermost layer, at the same time, or nearly at the same time, as applying the thermoplastic foil to the panel, for example on top of said intermediate layer by means of at least a pressing operation, for example with one or more lamination rollers.

According to a second possibility, said intermediate layer is based on a semi-crystalline or crystalline thermoplastic material, while said thermoplastic foil and/or said extruded substrate material is based on an amorphous thermoplastic material. A semi-crystalline or crystalline thermoplastic polymer is expected to shrink more than the extruded amorphous thermoplastic material of the substrate, while cooling. Such shrinking may lead to hollow portions in the surface of said outermost layer to become bridged. An intermediate layer based on a semi-crystalline thermoplastic material or crystalline material may comprise a mono-axial or biaxial orientation of the crystal structure. Such orientation preferably at least substantially or exactly coincides with the extrusion direction of said substrate material or the direction transverse to the extrusion direction in order to more fluently control any warping effects.

It is clear that the intermediate layer may at the same time fulfill the abovementioned first possibility and second possibility. Such can for example be the case when the thermoplastic foil and/or the extruded substrate material are based on polyvinylchloride (PVC), preferably unplasticized or with a plasticizer content of 5phr (weight parts by hundred weight parts of the PVC resin) or less, and the intermediate layer is based on polyethylene, polyethylene terephthalate or polypropylene.

Here below some specific and important examples for said intermediate layer are described, without desiring to be exhaustive.

According to a first specific example, said intermediate layer comprises, is based on, and/or is essentially made of polyethylene (PE). PE has a glass transition temperature below 0 °C, i.e. about −110 °C, and is therefore ideally suitable to be applied in a wide range of extruded substrate materials and decorative top layers. For example, it may conveniently be applied with an extruded substrate material and/or thermoplastic foil comprising polyvinylchloride (PVC), with or without plasticizers, polypropylene (PP), poly lactic acid (PLA), polyethylene terephthalate (PET) or glycol modified polyethylene terephthalate (PETG). An intermediate layer of PE may conveniently be provided as a prefabricated PE foil. The polyethylene may be of the high or low density type (LDPE or HDPE). Low density polyethylene may have a molecular weight between 30,000 and 50,000 g/mol. High density polyethylene may have a molecular weight of 200,000 g/mol or above. It is of course not excluded that a medium density polyethylene (MDPE) would be used, having a density from 50,000 g/mol to 200,000 g/mol. HDPE can be relatively sturdy and thereby able to bridge hollow portions of the outermost layer, while LDPE can be relatively soft and thereby able to fill such hollow portions. MDPE is able to provide a midway effect. Thanks to its sturdiness and strength, HDPE and MDPE may serve to provide an intermediate layer of low thickness, for example of a thickness lower than 100 micrometer, or even of 60 micrometer or lower, while still being able to offer the desired bridging effects.

According to a second specific example, said intermediate layer comprises, is based on, and/or is essentially made of a homo-or heteropolymer of polypropylene (PP). PP has a glass transition temperature below 0 °C, i.e. about −10 °C for the homopolymer, or lower in case of certain heteropolymers like PE-PP copolymer. The PP hetero-or homopolymer may be oriented, preferably in the extrusion direction of the substrate material. The relatively low glass transition temperature makes such intermediate layer ideally suitable to be applied in a range of technically interesting extruded substrate materials and decorative top layers. For example, it may conveniently be applied with an extruded substrate material and/or thermoplastic foil comprising polyvinylchloride (PVC), with or without plasticizers, poly lactic acid (PLA), polyethylene terephthalate (PET) or glycol modified polyethylene terephthalate (PETG).

According to a third specific example, said intermediate layer comprises, is based on, and/or is essentially made of poly lactic acid (PLA). PLA has a glass transition temperature of about 50 °C, and can still be used in combination with such thermoplastic foils and/or extruded substrate materials that are based on, or comprise, polyvinylchloride (PVC), without plasticizers or with a plasticizer content of 5 phr or less, polyethylene terephthalate (PET) or glycol modified polyethylene terephthalate (PETG).

According to a fourth specific example, said intermediate layer comprises, is based on, and/or is essentially made of a modified polyethylene terephthalate. Modification of polyethylene terephthalate may lead to a copolyester with a glass transition temperature, or even melt temperature, tailored for its application. For example, the modified polyethylene terephthalate may have a glass transition temperature of 0 °C or below. Modified polyethylene terephthalate may therefore be ideally suitable to be applied in a wide range of extruded substrate materials and decorative top layers. For example, it may conveniently be applied with an extruded substrate material and/or thermoplastic foil comprising polyvinylchloride (PVC), with or without plasticizers, polypropylene (PP), poly lactic acid (PLA), polyethylene terephthalate (PET) or glycol modified polyethylene terephthalate (PETG).

According to a fifth specific example, said intermediate layer comprises, is based on, and/or is essentially made of glycidyl methacrylate (GMA), glycidyl methyl methacrylate (GMMA), or copolymers of GMA and/or GMMA for example ethylene-glycidyl methacrylate copolymer (EGMA). The inventors have found that such intermediate layer may bring about a particularly high delamination resistance, in particular when applied on substrates comprising polyolefins, such polypropylene (PP), PET (polyethylene terephthalate) or PETG (glycol modified polyethylene terephthalate).

Preferably, said intermediate layer is applied as a prefabricated sheet material, for example based on one of the thermoplastic materials as mentioned in the above possibilities or specific examples. For example, the intermediate layer may be a applied as a prefabricated sheet of polyethylene, of polyethylene terephthalate, or of a copolymer of polyethylene terephthalate. Preferably said intermediate layer is a single layer, namely preferably provided as a single layered prefabricated sheet material of the respective thermoplastic material. Alternatively said intermediate layer may be multilayered. For example said intermediate layer may be a multilayered prefabricated sheet material. According to a special embodiment, said intermediate layer is a multilayered layer, whether or not formed by a multilayered prefabricated sheet material, wherein at least two of the layers comprised therein are based on mutually different thermoplastic materials. Preferably, the difference between said mutually different thermoplastic materials comprises at least a difference in glass transition temperature, for example of at least 10 °C, or at least 25 °C or at least a difference in crystallinity, for example of at least 15%. For example one layer may be based on an amorphous thermoplastic material, while another layer may be based on a semi-crystalline material with a crystallinity of 15% or more. According to another special embodiment, which may or may not show the characteristics of the above special embodiment, said multilayered layer comprises at least three layers, wherein the central layer is based on a different thermoplastic material than the two outer layers, which preferably have a same composition. Preferably the glass transition temperature and/or the melt temperature of the outer layers is lower than the glass transition temperature and/or, respectively, the melt temperature of the central layer. In such case a sturdy intermediate layer can be obtained that, by means of the outer layer, may lead to a good delamination resistance. The sturdy intermediate layer may serve as a carrier to introduce the material of the outer layers, which in itself may be less sturdy, into the panel composition. As a specific example of an intermediate multilayered layer, a combination of at least an HDPE layer and a LDPE layer may be used, or a combination of at least a coPET and a PET layer may be used. Herein, preferably the HDPE layer, respectively the PET layer, forms said intermediate layer or sturdy layer.

A prefabricated sheet material functioning as said intermediate layer, in accordance with the above preferred embodiment, may be applied in said decorative panel and/or to said substrate in a stretched manner. For example a prefabricated coPET sheet with an original thickness of more than 20 μm, e.g. about 25 μm, may be stretched 2 times or more, to yield a thickness in said decorative panel of below 15 μm, or even below 10 μm, for example of about 8 μm.

Instead of said decorative print being comprised of inks provided on a thermoplastic foil, said decorative print may comprise inks provided on one or more liquidly applied primer layers, wherein said intermediate layer is preferably present intermediate the surface of said outermost layer and said liquidly applied primer layers. Preferably, said intermediate layer is directly adjacent to the lowermost of said liquidly applied primer layers.

Preferably, the decorative panel, more particularly the decorative top layer, further comprises a wear layer applied on top of said decorative print.

In the cases where the decorative print is comprised of inks provided on a thermoplastic foil, the wear layer may comprise a transparent foil of a same or similar thermoplastic material. For example, in the cases where the inks are applied on a thermoplastic foil based on PVC, PP, PET or PE, the transparent foil is preferably based on respectively PVC, PP, PET or PE as well. The thermoplastic material of the transparent foil may however be different in that it comprises less or more types of additives, or a differing amount of additives, such as plasticizers or elastomers. The inks may for example be comprised on a PVC foil having a plasticizer content of 5 phr or less, while the transparent foil is a PVC foil having a plasticizer content of 10 phr or more. Alternatively, in the cases where the decorative print is comprised of inks provided on a thermoplastic foil, the wear layer may comprise a casted or liquidly applied thermoplastic material, that is preferably the same or similar. A transparent foil or liquidly applied thermoplastic layer may further be finished with a superficial lacquer coating, that is preferably UV and/or excimer cured. The superficial lacquer may, for example, be acrylic based or polyurethane based.

In the cases where said decorative print comprises inks provided on one or more liquidly applied primer layers, the wear layer may comprise one or more liquidly applied lacquer layers, such as acrylic based lacquer layers, that are preferably UV cured.

Preferably, said intermediate layer is directly adjacent to said surface of said outermost layer, or, alternatively, said intermediate layer is separated from said surface of said outermost layer exclusively by means of a glue layer, i.e. a layer forming an adhesive bound between said outermost layer and said intermediate layer.

It is clear that in the case of multilayered intermediate layers, one or more of the outermost layers may form said glue layer, in which case, it is the other layer, or the central layer, as the case may be, that is separated from the surface of said outermost layer of the substrate, or from the thermoplastic foil, by means of the material of the respective outermost layer of the multilayered intermediate layer.

From the above, it is clear that said intermediate layer is preferably a thermoplastic foil, for example a PE (polyethylene), PET (polyethylene terephthalate), coPET (copolymer of PET) or a PETG (polyethylene terephthalate glycol) film. According to another example, said intermediate layer is a PP (polypropylene) film or a film based on a copolymer of PP and PE. According to still another example, said intermediate layer is a PVC foil, for example a PVC foil with a plasticizer content of 15 phr or more, or of 20 phr or more and/or with a thickness of 75 micrometer or more, for example with a thickness of about 100 micrometer. It is clear that an intermediate layer comprising a thermoplastic foil may be applied in said decorative panel and/or onto said substrate in a stretched manner.

Preferably, as already illustrated above, said intermediate layer is based on a thermoplastic material different from the thermoplastic material of said substrate. Preferably, said extruded board material consists of a single layer of a first thermoplastic material and said decorative top layer comprises a decorative print provided on a film of said first thermoplastic material, wherein said intermediate layer comprises a second thermoplastic material. According to the most preferred embodiment, said first thermoplastic material is polyvinylchloride, and said second thermoplastic material is polyethylene or polypropylene or polyethylene terephthalate or coPET. Said single layer is preferably of a uniform or practically uniform composition and/or has been obtained by means of a single extruder.

Preferably, said intermediate layer has an average thickness of 5 micrometer or more, or of 20 micrometer to 200 micrometer and/or has an average thickness lower than the thickness of said decorative top layer, preferably an average thickness of 1% or larger, preferably between 5% and 85%, or between 10% and 25%, of the thickness or average thickness of said decorative top layer.

Preferably, said extruded board material is foamed and the material of intermediate layer bridges or fills open cells available at said outermost surface.

Preferably, said extruded board material is foamed and substantially comprises closed cells. The extruded board material may for example consist of a single foamed layer substantially comprising closed cells. Open cells may still be available but to a lower extent than the closed cells. In particular such open cells may be available at the surface of an outermost layer of said extruded substrate material. Also the presence of closed cells directly adjacent to the surface of said outermost layer of said extruded substrate material may profit from the advantages of the intermediate layer, for example the bridging leading to a lower risk of collapse of such cells or portions, and/or to a better delamination resistance.

It is noted that any closed cells within said extruded board material may be filled with air, or another gaseous substance, such as CO₂ or N₂, for example in case said outermost layer is foamed by means of injecting, whether or not liquefied CO₂ or N₂ in the extruder and/or between the extruder and a die having a slot nozzle for extrusion of said board material.

With a closed cell or hollow portion being directly adjacent to a surface, preferably cells or hollow portions are envisaged, wherein the shortest distance between the center of such cell or portion and said surface is less than the largest dimension of said cell or portion. Closed cells or hollow portions being at least partially positioned within 50 micrometer from the surface of said outermost layer are also regarded as being directly adjacent to said surface.

Preferably, said extruded board material, or at least said outermost layer, is filled with hollow filler materials, wherein said hollow filler materials are selected from the list consisting of glass beads, expanded polystyrene, pumicite and vermiculite. The inventor has found that the use of mineral hollow fillers, such as glass beads, pumicite and vermiculite, are particularly advantageous for the strength of any coupling parts that are provided in the material of the substrate, more particularly are provided at least partially in said outermost layer, whether or not the intermediate layer of the first independent aspect has been applied. Preferably, in the case of glass beads, the filler material comprises hollow glass spheres having a density of 1 gram per cubic centimeter or below. Therefore, in accordance with a particular independent aspect, the present invention is a decorative panel, preferably a decorative floor panel, wherein said decorative panel is rectangular, i.e. square or oblong, and comprises at least a substrate and a decorative top layer, characterized in that said substrate comprises one or more layers of thermoplastic material filled with at least glass beads, alternatively at least with pumicite and/or vermiculite, and wherein said panel at at least two opposite edges comprises coupling means allowing that two of such panels at the respective edges can be coupled together, wherein, in a coupled condition, a locking is obtained in a direction perpendicular to the plane of coupled panels, and in a direction perpendicular to the coupled edges and in the plane of coupled panels, wherein said coupling means are at least partially, for example at least for 70 percent of their circumference, provided in said one or more layers of thermoplastic material which are filled with at least glass beads, alternatively at least with pumicite and/or vermiculite. Preferably at least one pair of horizontally active locking surfaces and/or one pair of vertically active locking surfaces are formed in said one or more layers, as will further be elucidated by means of the attached drawings and their detailed description. Preferably, said one or more layers of thermoplastic material are foamed. It is clear that the substrate of the decorative panel of the present particular independent aspect is preferably an extruded board material. The inventors note that the use of glass beads may have a beneficial effect on the wear of the extruder screw and barrel.

Preferably, said panel has a total density being between 0.8 and 1.25 times the density of the thermoplastic material applied in said extruded board material. The use of hollow portions formed by hollow filler materials and/or by foaming may herein account for a density reduction. The use of non-hollow filler materials, such as chalk or other mineral fillers, may lead to an economization of thermoplastic material, but may add to the density of the thermoplastic composite material or the extruded board 11aterial, however due to the foaming and/or content of hollow filler materials, the density of the panel and/or the extruded board material is preferably kept below 1.25 times the density of the thermoplastic material.

It is clear that said extruded board material may further comprise filler materials having a density higher than the density of the thermoplastic material applied in said extruded board material, such as mineral fillers, for example chalk or talcum.

Preferably, the weight ratio mineral fillers: thermoplastic material in said extruded board material as a whole, or in any or all of said one or more layers of said extruded board material is 1:1 or higher, for example 2:1 or higher. Preferably said extruded board material comprises at least one layer where said weight ratio is 1:1 or above, e.g. at least 2:1.

Said extruded board material may comprise nitrile rubber and/or oxidized polyethylene wax and/or TPU (thermoplastic polyurethane) as an additive to a mix that otherwise e.g. comprises at least polyvinyl chloride and filler materials. Nitrile rubber, oxidized polyethylene wax and TPU have a plasticizing effect, and lead to a more fluent kneading process in the extruder. The wear on the extruder barrel and screws may be minimized.

Preferably, said foaming and/or filling with hollow filling materials brings about a density reduction of the extruded substrate material of at least 20% as compared to an unfoamed variant of such extruded substrate material that is free from hollow filler materials.

Preferably, the decorative panel of the invention at at least two opposite edges comprises coupling parts or coupling means allowing to couple two such panels at the respective edges, such that in a coupled condition a locking is obtained between said edges in a direction perpendicular to the plane of coupled panels, and in a direction perpendicular to the coupled edges and in the plane of the coupled edges. Preferably such coupling parts are substantially formed as a tongue and groove, provided with locking parts preventing the drifting apart of the tongue and the groove in said direction perpendicular to the coupled edges. An example of such coupling parts is further illustrated in the detailed description with reference to the attached figures, wherein the locking parts comprise the there mentioned horizontally active locking surfaces.

Preferably, the decorative panel of the invention comprises a substrate on the basis of an extruded board material, wherein said extruded board material forms at least half of the thickness of said decorative panel. As stated before, said substrate may be a single layered extruded board material that is foamed and/or filled with hollow filler materials such as glass beads. Such single layered extruded board material is preferably obtained through the use of a single extruder and/or has a uniform or substantially uniform composition, especially in its thickness direction, for example with the exception of one or both outermost surfaces. One or both outermost surfaces may be slightly differently foamed or filled due to boundary effects.

Preferably, said decorative panel has a thickness of 4 to 9 mm.

Said decorative panel may comprise an additional layer or backing layer, for example of a foamed material, such as XPE (crosslinked polyethylene). Preferably, such backing layer is glued to the bottom of said extruded board material, or to the bottom of said substrate.

With the same aim as in said first aspect, the present invention in accordance with its second independent aspect is a method for manufacturing a decorative panel, with as a characteristic that said method comprises at least the following steps:
the step of extruding a board material, for example by means of at least one extruder, wherein said board material comprises one or more layers of thermoplastic material and wherein the outermost layer of said extruded board material is foamed and/or filled with hollow filler materials;
the step of providing an intermediate layer on said outermost layer;
the step of providing a decorative top layer on said intermediate layer.

Preferably said extruder comprises at least one screw, wherein said screw comprises a transporting section, and at least one compression section. The compression section may be followed, in transport direction of the material to be extruded, by a decompression section, where potentially air and/or other volatiles are sucked off, and/or by a mixing section. In the mixing section the screw and/or the barrel may be provided with pins to enhance the mixing. More generally, at the location of the mixing section, the screw may be provided with interrupted protrusions, i.e. with protrusion that are discontinuous over the circumference of the mixing section. Said interrupted protrusions may be pins or have a different shape, such as a pineapple or fin shape.

According to the most preferred embodiment, said extruder is a twin screw extruder, preferably a conical or superconical twin screw extruder. Preferably both screws comprise a transporting section and at least one compression section, potentially followed by a decompression section and/or a mixing section.

The method of the second aspect is ideally suited to manufacture the decorative panels of the first aspect and the preferred embodiments thereof.

It is noted that in said step of extruding said board material, at least one extruder preferably feeds a die having a slot nozzle, wherein said slot nozzle preferably has an opening configured to produce said extruded board material, i.e. preferably at least with a height and width corresponding, or about corresponding, to the thickness and the width of said extruded board material.

As stated above, the use of hollow filler materials comprising glass beads may have a beneficial effect on the wear of the extruder screw and barrel. Preferably such glass beads are hollow glass spheres having a density of 1 gram per cubic centimeter or below, for example 0.5 gram per cubic centimeter or below.

Preferably, said step of extruding is effected by means of at least one extruder and comprises injecting a gaseous substance, whether or not liquefied, e.g. CO₂, N₂ or a pentane, into an extruder, or into the part linking the extruder outlet with the die. The gaseous substance may be injected in a pulsating manner and/or at a pressure of 100-200 bar, preferably 120-180 bar. The inventors note that a very homogeneous foam comprising microcells can be obtained in this manner. Said microcells may have an average cell diameter of 75 micrometer or below, or even of 50 micrometer or below. As mentioned above, preferably a twin screw extruder is applied, comprising screws, each having a transporting section, and at least one compression section, potentially followed by a decompression section, where air or other volatiles may be sucked off, and/or a mixing section, where the screws may be provided with pins, fins or other interrupted protrusions. When the injection is into the extruder, this is preferably done at the location of the mixing section of a twin screw extruder. When the injection is performed in between the extruder outlet and the die, this is preferably done at the location of an additional mixing screw positioned between said outlet and said die.

According to an alternative, a foaming agent may be comprised in the material to be extruded, such as natrium bicarbonate or azodicarbonamide.

Preferably, at least said foamed outermost layer comprises talcum, i.e. hydrated magnesium silicate, for example with the chemical formula Mg₃Si₄O₁₀(OH)₂. Talcum has a pointy particle form. Foaming may by preference start at these particles. By using talcum in the composition to be extruded a more fluent and uniform foaming can be obtained. Preferably said foamed outermost layer comprises at least 3 wt % of talcum, or at least 5 wt % of talcum, e.g. about 7 wt % of talcum. Said foamed outermost layer may further also comprise CaCO₃ as a filler material. The total content of talcum and CaCO3 together in said outermost layer may be between 50 wt % and 85 wt %.

Preferably the intermediate layer is as mentioned in the first aspect and/or its preferred embodiments. For example, the intermediate layer is preferably formed as a prefabricated single or multilayered sheet material, wherein, preferably, said sheet material comprises at least one layer, for example the single layer as the case may be, of a thermoplastic material that is different from the thermoplastic material of the extruded substrate material and/or the material contained in the decorative top layer.

According to a variant, the intermediate layer is provided inline with said step of extruding said board material. For example, the intermediate layer may be extruded as well, through a separate nozzle, or through a same nozzle as said extruded board material.

The one or more thermoplastic materials of the intermediate layer may be chosen in accordance with the possibilities and specific examples listed in connection to the first aspect of the invention.

For the step of providing said decorative top layer, a decorative print and/or a wear layer as the case may be, the techniques mentioned in the first aspect may be used. For example, the step of providing said decorative top layer may comprise the step of providing a decorative print by liquidly applying one or more primer layers, and subsequently providing inks on said one or more primer layers, wherein said intermediate layer is preferably present intermediate the surface of said outermost layer and said liquidly applied primer layers. Preferably, said intermediate layer is directly adjacent to the lowermost of said liquidly applied primer layers. Alternatively, instead of using liquidly applied primer layers, the step of providing said decorative top layer may comprise the step of providing a decorative print by applying a printed thermoplastic foil, or by applying a thermoplastic foil and subsequently providing inks on said thermoplastic foil, wherein said intermediate layer is preferably present intermediate the surface of said outermost layer and said thermoplastic foil. Preferably, the step of applying said decorative top layer further comprises the step of providing a wear layer on top of said decorative print. For example, the wear layer may be provided at least by casting or otherwise liquidly applying a thermoplastic material, or at least by applying a transparent thermoplastic foil.

Preferably, said step of extruding is followed by a cooling operation by means of one or more cooled plates or cooled rollers. A cooling operation may be applied in order to control the formation of skimming layers, i.e. unfoamed layers, at the surface of the extruded board material. Preferably, the skimming is controlled such that closed cells are available at the surface of said outermost layer, wherein the shortest distance between the center of such cell and said surface is less than the largest dimension of said cell or portion and/or wherein closed cells being at least partially positioned within 50 micrometer from the surface of said outermost layer. Preferably, the cooling operation starts or is carried out within the first meter, as measured along the trajectory of the extruded board material, from the die opening, preferably within the first 50 centimeter, and/or before said intermediate layer is provided. Preferably said cooling operation is performed by transporting the extruded board material through the nip formed by one, two, or more pairs of rollers. These pairs of rollers may be positioned in proximity of said die opening, i. e at least partially within the first meter or first half a meter from the die opening. Preferably said rollers have a diameter of 500 mm or less, e.g. about 200 mm.

It is clear that the present invention, in an independent manner, also relates to multilayered sheet materials as mentioned in connection to the first aspect, which are preferably suitable for being applied as an intermediate layer in the decorative panel of the first aspect and/or the method of the second aspect.

As described above, several measures may be taken to obtain an enhanced foaming and/or a minimized extruder wear. It is clear that such measures are also of importance irrespective of the application of an intermediate layer. It is hence clear that the present invention in accordance with a third independent aspect also is a decorative panel comprising at least a substrate and a decorative top layer, wherein said substrate is or comprises an extruded board material and wherein said decorative top layer at least comprises a decorative print, characterized in that said extruded board material shows one or a combination of two or more of the following properties:
the extruded board material comprises hollow glass spheres having a density of 1 gram per cubic centimeter or below;
the extruded board material comprises or consists of a foamed layer, wherein said foamed layer comprises at least 3 wt %, at least 5 wt % or at least 7 wt % of talcum;
the extruded board material comprises or consists of a foamed layer, wherein the cells of said foam have an average diameter of 75 micrometer or below, or of 50 micrometer or below;
the extruded board material comprises or consists of a foamed layer, wherein the foamed layer comprises closed cells available at the surface thereof, wherein the shortest distance between the center of such cell and said surface is less than the largest dimension of said cell and/or wherein one or more closed cells are at least partially positioned within 50 micrometer from said surface;
the extruded board material comprises or consists of a foamed layer, wherein the cells of said foamed layer are filled with CO₂ or N₂;
the extruded board material comprises nitrile rubber and/or oxidized polyethylene wax and/or TPU (thermoplastic polyurethane) and/or epoxidized soybean oil as an additive to a mix comprising at least polyvinyl chloride and filler materials.

Preferably the extruded board material of said third independent aspect is basically, or essentially formed from a composition comprising at least polyvinyl chloride and filler materials, such as CaCO₃ and/or talcum. Preferably the total content of talcum and CaCO3 is between 50 wt % and 85 wt % in said composition.

In accordance with a fourth independent aspect, the invention is a method for manufacturing decorative panels that may yield minimized extruder wear and/or optimized foaming. With this aim, the invention is a method for manufacturing decorative panels, wherein the method comprises the step of extruding a board material through a die by means of at least one extruder comprising an extruder screw, characterized in that said method further shows one or a combination of two or more of the following properties:
the extruded board material comprises hollow glass spheres having a density of 1 gram per cubic centimeter or below. The use of glass spheres may minimize wear on the extruder screw and/or extruder barrel;
the extruded board material comprises or consists of a foamed layer, wherein said foamed layer comprises at least 3 wt %, at least 5 wt % or at least 7 wt % of talcum;
the extruded board material comprises or consists of a foamed layer, wherein the cells of said foam have an average diameter of 75 micrometer or below, or of 50 micrometer or below;
the extruded board material comprises or consists of a foamed layer, wherein the foamed layer comprises closed cells available at the surface thereof, wherein the shortest distance between the center of such cell and said surface is less than the largest dimension of said cell and/or wherein one or more closed cells are at least partially positioned within 50 micrometer from said surface;
the extruded board material comprises or consists of a foamed layer, wherein the cells of said foamed layer are filled with CO₂ or N₂;
the extruded board material comprises nitrile rubber and/or oxidized polyethylene wax and/or TPU (thermoplastic polyurethane) and/or epoxidized soybean oil as an additive to a mix comprising at least polyvinyl chloride and filler materials. These substances may have a plasticizing effect, and may minimize the energy needed for kneading in the extruder;
a gaseous substance, whether or not liquefied, e.g. CO₂, N₂ or a pentane, is injected into said extruder and/or in the part linking the extruder outlet with said die. Preferably the injection is performed in a pulsating manner and/or at a pressure of 100-200 bar. Preferably said extruder screw has a transporting section and at least one compression section, followed by at least a mixing section, where the screw is preferably provided with pins or other interrupted protrusions, wherein said injection is preferably at least done at the location of said mixing section;
the extruded board material comprises a foamed layer, and said step of extruding is followed by a cooling operation by means of one or more cooled plates or cooled rollers. Preferably said cooling operation starts or carried out within the first meter from the die opening, as measured along the trajectory of the extruded board material, preferably within the first 50 centimeter from the die opening and/or before a potential further layer, i.e. an intermediate layer and/or a decorative layer portion, is applied to said extruded board material. Preferably said cooling operation is at least performed by transporting the extruded board material through the nip formed by one, two or more pairs of rollers. Preferably said rollers have a diameter of 500 mm or below, e.g. a diameter of about 200 mm;
said extruded board material preferably comprises or consists of a foamed layer, wherein the extruded board material is transported through a nip created between two opposing surfaces, wherein the respective surfaces of said extruded board material are distanced from said opposing surfaces by means of a stream of liquid or gas. Preferably a stream of air is applied. Preferably said opposing surfaces perform a calibrating treatment, or a levelling treatment on the respective surfaces of the extruded board material. The stream of air may minimize the friction on the surfaces, and minimize the energy needed for performing the treatment. Preferably said opposing surfaces are plates having a flat surface facing the respective surfaces of said extruded board material. Preferably the extruded board material is transported through said nip before the application of any further layers, such as an intermediate layer or a portion of a decorative top layer. According to a special embodiment the transport through said nip forms a cooling operation, and is preferably started within the first meter from the die opening and/or before a potential further layer, i.e. an intermediate layer and/or a decorative layer portion is applied, as mentioned above;
said extruder screw at least comprises a mixing section, wherein said screw at the location of said mixing section comprises pins or other interrupted protrusions distributed on its circumference, for example in the form of interrupted spirals or interrupted spiraling fins, e.g. a so-called Saxton type mixer, or protruding cubes forming pineapple texture. Preferably the mixing section is positioned in proximity, preferably just in front, of the extruder outlet, preferably the extruder screw is free from uninterrupted protrusions at locations between said mixing section and said extruder outlet. Preferably the extruder barrel has an opening at the location of said mixing section, or right in front of said mixing section, for adding additional components, such as whether or not liquefied gaseous substances, filler materials and/or other additives.

The extruded board material obtained through the fourth independent aspect is ideally suited for being applied in the context of the third independent aspect. It is clear that measures that minimize extruder wear, may also minimize the energy consumption of the extrusion line.

It is further clear that the decorative panels of the third independent aspect and/or comprising an extruded board material, as e.g. a substrate or part thereof, wherein this extruded board material is obtained by means of the fourth independent aspect, may further show the features of the first independent aspect and/or said particular independent aspect and/or be obtained through the method of the second aspect and/or the preferred embodiments thereof without there necessarily being an intermediate layer.

The inventors have noted that the application of an intermediate layer as described in the context of the first and/or second aspect of the invention may also have beneficial effects independent of the substrate comprising an outermost layer that is foamed and/or filled with hollow filler materials. An intermediate layer may also be used for levelling out surface imperfections of an extruded or otherwise obtained board material, as well as for promoting adhesion between the board material and the decorative top layer. This is in particular the case when the substrate, or its outermost layer, is formed by a polyolefin, such as by a polypropylene containing material. Therefor, in accordance with a fifth independent aspect, the present invention is a decorative panel comprising at least a substrate and a decorative top layer, wherein said substrate is or comprises a, preferably extruded, board material comprising one or more layers of thermoplastic material and wherein said decorative top layer at least comprises a decorative print, with as a characteristic that an intermediate layer is present intermediate the surface of an outermost layer of said substrate or board material and said decorative print.

Said thermoplastic material may show one or more of the following properties:
the property that said thermoplastic material is filled with filler materials, preferably of the types and to the extents mentioned in connection to the first and/or second independent aspects and/or the preferred embodiments thereof;
the property that said thermoplastic material is a foamed thermoplastic material, identically or similarly as mentioned in connection to the aspects named above and/or the preferred embodiments thereof;
the property that said thermoplastic material comprises a polyolefin, preferably a homopolymer or a heteropolymer of polypropylene;
the property that said thermoplastic material comprises a polyester, preferably polyethylene terephthalate or glycol modified polyethylene terephthalate.

Most preferably, said substrate is a filled polyolefinic material, for example filled polypropylene, in homopolymeric or heteropolymeric form.

It is clear that the substrate may either be foamed or unfoamed, or in other words substantially or essentially free from voids.

It is especially for substrates having one or more of the above properties that the use of an intermediate layer is of relevance. In the case of filled thermoplastic materials, especially where the weight ratio filler: thermoplastic material is above 1:1, or even above 2:1, the surface of said outermost layer may be uneven. The uneven surface may create problems with adhesion of the decorative top layer. An intermediate layer in accordance with the fifth independent aspect may minimize such delamination problems. In the case of a foamed thermoplastic material, the intermediate layer may minimize delamination problems, e.g. caused by the presence of closed cells directly adjacent to the surface of said outermost layer as described in the context of the first aspect of the invention. In the case said thermoplastic material comprises a polyolefin, such as polypropylene, delamination problems may exist due to the non-polarity and/or low surface energy of polyolefins, especially of polypropylene. Also other thermoplastic materials, like ABS (acrylonitrile butadiene styrene), may suffer from similar delamination issues.

For the intermediate layer, the specific examples listed in the context of the first independent aspect may be applied. Especially, and certainly in the case said thermoplastic material comprises a polyolefin, such as polypropylene, the fourth specific example is of special interest. Thus, preferably, said intermediate layer comprises, is based on, and/or is essentially made of a modified polyethylene terephthalate. For example, the modified polyethylene terephthalate may have a glass transition temperature of 0 °C or below.

Preferably, said intermediate layer is directly adjacent to said surface of said outermost layer.

Preferably, said intermediate layer is a thermoplastic foil, for example a PE (polyethylene), PET (polyethylene terephthalate), coPET (copolymer of PET) or a PETG (polyethylene terephthalate glycol) film. An intermediate layer comprising or consisting of a thermoplastic foil may be applied in said decorative panel and/or onto said substrate in a stretched manner.

According to the most preferred embodiment, said intermediate layer comprises or consists of polyethylene terephthalate or coPET.

Preferably, said intermediate layer has an average thickness of 5 micrometer or more, or of 20 micrometer to 200 micrometer and/or has an average thickness lower than the thickness of said decorative top layer, preferably an average thickness of 1% or larger, preferably between 5% and 85%, or between 10% and 25%, of the thickness or average thickness of said decorative top layer.

Preferably, the intermediate layer formed as a prefabricated single or multilayered sheet material. According to a variant, the intermediate layer is provided in line with the step of providing, e.g. extruding, said board material. For example, the intermediate layer may be extruded as well, through a separate nozzle, or through a same nozzle as said extruded board material.

A prefabricated sheet material functioning as said intermediate layer, may be applied in said decorative panel and/or to said substrate in a stretched manner. For example a prefabricated coPET sheet with an original thickness of more than 20 μm, e.g. about 25 μm, may be stretched 2 times or more, to yield a thickness in said decorative panel of below 15 μm, or even below 10 μm, for example of about 8 μm.

Another specific embodiments of the said fifth independent aspect includes the following:
a decorative panel comprising at least a substrate and a decorative top layer, wherein said substrate is or comprises a board material comprising one or more layers of thermoplastic material and wherein said decorative top layer at least comprises a decorative print, with as a characteristic that an intermediate layer is present intermediate the surface of an outermost layer of said substrate or board material and said decorative print. Herein said board material may be an extruded board material.
Said one or more layers of thermoplastic material may be
   a plurality of layers or comprise a layer of filled thermoplastic material wherein the weight ratio filler: thermoplastic material is above 1:1;
   a plurality of layers or comprise a layer of foamed thermoplastic material; and/or
   a plurality of layers or comprise a layer of, preferably filled, poly olefinic material, such as polypropylene, or of, preferably filled, polyvinyl chloride, wherein said polyvinyl chloride is preferably unplasticized or comprises a plasticizer content of 5 phr or less.
Said intermediate layer may be based on and/or be essentially made of a polyethylene terephthalate, preferably a glycol modified polyethylene terephthalate or a copolymer of polyethylene terephthalate. Alternatively, said intermediate layer is based on and/or is essentially made of glycidyl methacrylate (GMA), glycidyl methyl methacrylate (GMMA), or copolymers of GMA and/or GMMA, for example ethylene-glycidyl methacrylate copolymer (EGMA). The intermediate layer preferably has an average thickness of 5 micrometer or more, wherein said average thickness is preferably lower than the thickness of said decorative top layer.
Said decorative print may comprise inks provided on a thermoplastic foil, wherein said intermediate layer is present intermediate said substrate or board material and said thermoplastic foil, wherein said intermediate layer is preferably directly adjacent to said thermoplastic foil.
Most preferably said intermediate layer is based on a thermoplastic material different from the material of said thermoplastic foil and/or said board material. The most important examples being said intermediate layer based on and/or essentially made of a polyethylene terephthalate, preferably a glycol modified polyethylene terephthalate or a copolymer of polyethylene terephthalate, alternatively, said intermediate layer is based on and/or is essentially made of glycidyl methacrylate (GMA), glycidyl methyl methacrylate (GMMA), or copolymers of GMA and/or GMMA., and said board material being a whether or not foamed, preferably filled, polypropylene or polyvinylchloride extruded board material. In the case of polyvinyl chloride, this concerns preferably an unplasticized PVC or with a content of plasticizer of 5 phr or less.
Preferably, said substrate is a single layered board material, wherein said floor panel essentially consists of said board material, said intermediate layer and potentially a backing layer adhered or glued to the bottom of said board material, wherein said intermediate layer is intermediate and directly adjacent to a first surface of said board material and to said decorative layer. Said decorative print is preferably comprised of inks provided on a thermoplastic foil. Preferably said decorative layer further comprises a wear layer applied on top of said decorative print.

The present inventors have found that certain additives may further increase the delamination resistance in panels having a substrate comprising an outermost layer that is foamed and/or filled with hollow filler materials, and/or having a substrate, or an outermost layer, formed by a non PVC thermoplastic material and/or by a polyolefin, such as by polypropylene containing materials, and/or by a polyester, such as by polyethylene terephthalate or glycol modified polyethylene terephthalate. Such additives are then preferably added to said substrate, more particularly to an outermost layer thereof, and/or to a potential intermediate layer and/or to one or more thermoplastic foils comprised in the top layer of such panel. The incorporation of these additives forms a sixth independent aspect of the present invention. Therefor the sixth independent aspect of the present invention is a decorative panel comprising at least a substrate and a decorative top layer, wherein said substrate comprises one or more layers of thermoplastic material, preferably polypropylene, polyethylene terephthalate or glycol modified polyethylene terephthalate, characterized in that said at least one of said one or more layers of thermoplastic material and/or said decorative top layer and/or an optional intermediate layer available between said substrate and said decorative layer, comprise one or more of
glycidyl methacrylate (GMA), glycidyl methyl methacrylate (GMMA), a copolymer of GMA and/or GMMA, for example ethylene-glycidyl methacrylate copolymer (EGMA);
ethylene acrylate, ethylene terpolymer, a copolymer of ethylene and methacrylate;
an ionomer, preferably a sodium ionomer. Preferably the ionomer is a low molecular weight ionomer;
methyl methacrylate butadiene styrene copolymer (MBS);
chlorinated polypropylene (CPP);
ethyl vinyl acetate (EVA);
butene copolymer, such as butene alfa-olefinic copolymer; and
propylene copolymer, such as propylene based alfa-olefinic copolymer.

GMA is for example available in the market as Lotader AX-8840 or AX-8900. Ethylene acrylate is available as Fusabond A560. Ethylene terpolymer is available as Elvaloy PTW van Dupont. A copolymer of ethylene and methacrylate is available as Dupont AC1330. A sodium ionomer is available on the market as Aclyn. MBS is available on the market as KaneAce M732. Butene alfa-olefinic copolymer is available on the market as TAFMER BL grades, for example BL2481M, and propylene based alfa-olefinic copolymer is available on the market as TAFMER XM grades

Preferably 1 to 9 percent by weight of such additive is added in the respective layer, more preferably 2 to 5 percent by weight. Alternatively 1 to 9 parts by weight per 100 parts of the thermoplastic material, more preferably 2 to 5 parts by weight per 100 parts of the thermoplastic material is added to the respective layer. The inventors note the incorporation of such amount may lead to a lowered glass transition temperature and/or melting temperature. A better delamination resistance might be obtained with one or more layers comprises in the top layer. In particular layers comprising or substantially consisting of polyurethane based lacquers are better bound to an underlying layer comprising such additive, in particular in the amounts listed herein.

The inventors note that said additives may also improve the planarity of the substrate when applied in one or more layers of said substrate, both immediately after production, as in use.

It is clear that the decorative panel of the sixth independent aspect need not necessarily comprises an intermediate layer, but may comprise an intermediate layer. In the latter case a preferred embodiment of said first, third and/or fifth independent aspect, and/or the preferred embodiments thereof, may be obtained. It is clear that such panel may be manufactured with a method having the characteristics of said second and/or fourth independent aspect of the invention, and/or the preferred embodiments thereof.

Decorative panels of the sixth independent aspect may further show the characteristics of the panels of any of the other independent aspect without necessarily practicing an intermediate layer. For example the decorative top layers, the decorative prints, the decorative printed foils, the transparent foils, the foaming characteristics, in particular the cell characteristics of the foam, the use of hollow filler materials, the density, the weight ratio mineral filles: thermoplastic material, the coupling parts, the thickness of respective layers described in connection to the first independent aspect may all individually or in combination be applied in a panel and form respective preferred embodiments of the sixth independent aspect.

With the intention of better showing the characteristics according to the invention, in the following, as an example without limitative character, some embodiments are described, with reference to the accompanying drawings, wherein:

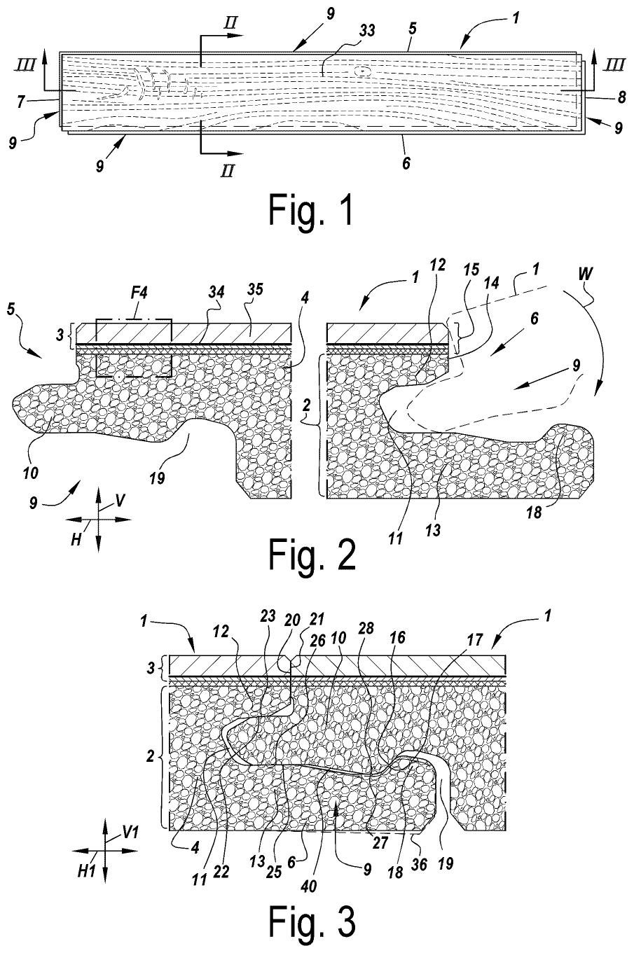

FIG. 1 shows a decorative panel in accordance with the invention;

FIGS. 2 and 3 at a larger scale illustrates a cross-section in accordance with the lines II-II and III-III respectively, as indicated in FIG. 1;

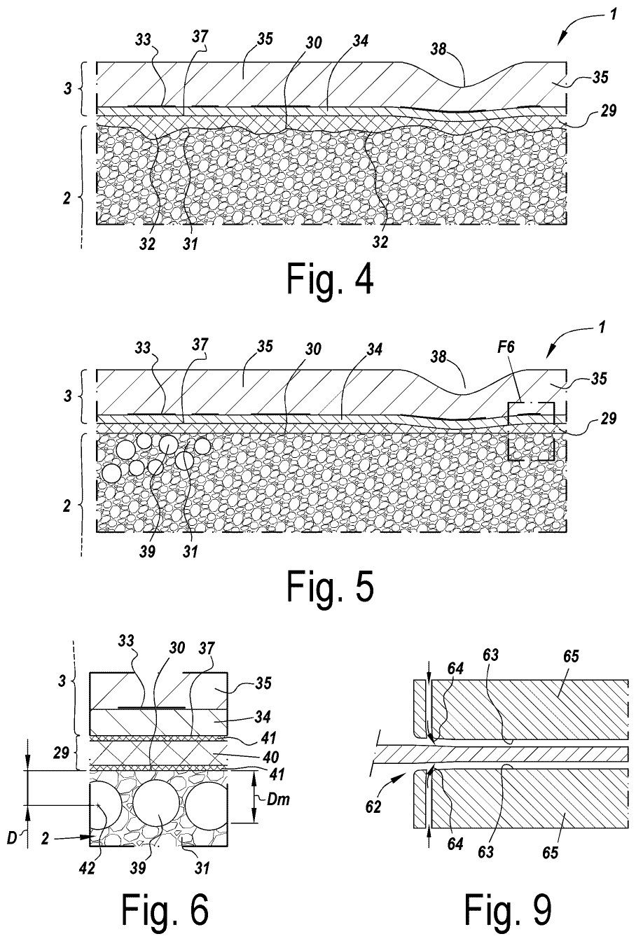

FIG. 4 at a larger scale gives a view on the area indicated with F4 in FIG. 2;

FIG. 5 in a same view illustrates a variant;

FIG. 6 at a larger scale, and for a variant, gives view on the area indicated with F6 in FIG. 5;

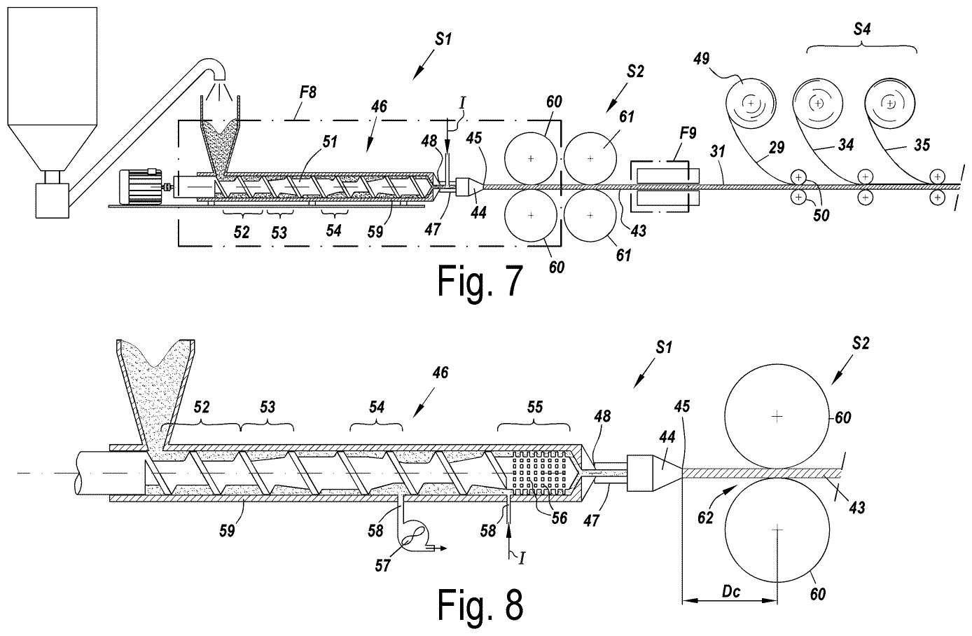

FIG. 7 illustrates some steps in a method for manufacturing a decorative panel in accordance with the second independent aspect;

FIG. 8, for a variant and at a larger scale, illustrates the area indicated with F8 in FIG. 7; and

FIG. 9 at a larger scale gives a view on the area indicated with F9 on FIG. 7.

FIG. 1 represents a rectangular floor panel 1. In this case the floor panel 1 is rectangular and oblong.

FIG. 2 clearly shows that the floor panel 1 comprises a substrate 2 and a provided thereon decorative top layer 3.

The substrate 2 comprises foamed PVC 4, in this case a single layered extruded foamed PVC having a plasticizer content of less than 5 phr, and is provided on at least two opposite edges 5-6-7-8, and in this case on the pair of long opposite edges 5-6 as well as on the pair of short opposite edges 7-8, with mechanical coupling means 9.

FIG. 2 clearly shows that the coupling means 9 on the long opposite edges 5-6 substantially are realized as a tongue 10 and a groove 11 with an upper lip 12 and lower lip 13. In this case, the aforementioned lower lip 13 extends in horizontal direction to beyond the distal end 14 of the upper lip 12. The represented coupling means 9 allow at least a coupling by means of a turning movement W along the respective edges 5-6.

FIG. 3 shows that in the coupled condition a locking is obtained in horizontal direction H1 perpendicular to the coupled edges 5-6 and in the plane of the panels 1, as well as in vertical direction V1 perpendicular to the plane of the coupled panels 1. The coupling means 9 consist of milled profiles, which for at least 70 percent of their circumference are provided in the substrate 2 and, in this case out of the PVC polymer 4. In this case, the coupling means 9 are provided practically entirely in the extruded and foamed PVC material of the substrate 2, with the exception of the portion 15 of their circumference being formed at least on the decorative top layer 3.

FIG. 3 represents that at least one pair of horizontally active locking surfaces 16-17 of the coupling means 9 is realized in the PVC material 4 of the substrate 2. Herein, this relates to a first pair of locking surfaces 16-17 formed on a protruding locking portion 18 of the lower lip 13 and a cooperating therewith locking groove 19 on the lower side of the tongue 10. A second pair of horizontally active locking surfaces 20-21 is formed in the example at least on the decorative top layer 3, or the aforementioned portion 15 of the circumference of the coupling means 9. Several pairs of the vertically active locking surfaces 22-23-25-26 are formed of the extruded PVC material 4 of the substrate 2. Herein, this relates at least to a first pair of vertically active locking surfaces 22-23 on the upper side of the tongue 10 and the lower side of the upper lip 12 of the groove 11, and at least a second pair of vertically active locking surfaces 25-26 on the lower side of the tongue 10 and the upper side of lower lip 13 of the groove 11. In the example of FIG. 3, the second pair of vertically active locking surfaces 25-26 is formed such that they extend at least horizontally at a position vertically underneath the aforementioned upper lip 12. In this case, also a third pair of vertically active locking surfaces 27-28 is formed in the proximity of the aforementioned first horizontally active locking surfaces 16-17.

The aforementioned decorative top layer 3 comprises a printed motif 33 and represents a single wooden plank. The printed motif 33 is provided on a thermoplastic foil 34, namely in this case, an unplasticized PVC foil. The floor panel 1 further also comprises a translucent or transparent wear layer 35, which is provided above the aforementioned decoration or printed motif 33.

It is noted that, according to a not represented embodiment, a floor panel 1 according to the invention may show an additional layer on the lower side of the substrate 2. Herein, this preferably relates to a foam layer, for example, of cross-linked or irradiation crosslinked polyethylene (XPE), which is fixed to the lower side of the substrate 2 by means of glue.

Further, it is noted that in the coupled condition of FIG. 3 a tension force can be obtained between the respective floor panels 1, more particularly at the location of the second pair of horizontally active locking surfaces 20-21, namely between the respective decorative top layers 3 on the upper edges of the coupled floor panels 1. In dashed line 36 in FIG. 3 is represented that such tension force can be obtained, for example, in that the lower lip 13 in the coupled condition is spring-deflected and in the coupled condition pushes against the tongue 10. Such pretension is known as such, for example, from WO 97/47834.

According to a not-represented variant of FIG. 3, instead of a pretension, a so-called play may be present in the coupled condition. In such case, in a coupled condition, some space may be available between the first pair of horizontally active locking surfaces 16-17, while a second pair of horizontally active locking surfaces is in contact at a position above the vertically active contact surfaces 22-23 between the upper side of the tongue 10 and the lower side of the upper lip 12 of the groove 11. Such space preferably extends over a horizontal distance of 0.2 mm or smaller.

At the opposite short edges 7-8 of the floor panel 1 in the example of FIGS. 1 to 3 the same coupling means 9 are applied as at the long opposite edges 5-6. This is however not necessarily the case, and other coupling means may for example be applied at the opposite short edges 7-8, such as coupling means allowing to obtain a coupled condition by means of a downward motion of one such panel edge 7 to another such panel edge 8.

It is clear that, when instead of being foamed, or in combination with being foamed, the substrate 2 of FIGS. 1 to 3 would be filled with hollow filler materials, such as glass beads, it would form an illustration of the particular independent aspect mentioned in the introduction.

FIG. 4 illustrates that an intermediate layer 29 is present intermediate the surface 30 of an outermost layer 31 of the substrate 2 and said decorative print 33. In this case, the intermediate layer 29 is directly adjacent the surface 30 of said outermost layer 31 and directly adjacent to said thermoplastic foil 34 having the decorative print 33 applied thereon.

The intermediate layer 29 is based on a thermoplastic material different from the material of the thermoplastic foil 34 that carries the decorative print 33. In this case the thermoplastic material of the intermediate layer 29 is polyethylene. In the example of FIG. 4, the intermediate layer 29 fills open cells 32 available at the outer surface 30 of said outermost layer 31. It is clear that the open cells 32 form excavations in the outer surface 30, that are now filled by means of the intermediate layer 29.

The surface 37 of said intermediate layer 29 that faces away from said outermost layer 31 extends over said open cells 32 in a planar manner. The surface 37 of said intermediate layer 29 is substantially level with the exceptions of embossments 38 provided in said decorative layer 3 that extend into said intermediate layer 29.

FIG. 5 illustrates an alternative where hollow portions 39 are available immediately adjacent said outermost layer 31. In the case of FIG. 5 the hollow portions 39 are formed by closed cells of said foam.

FIG. 6 shows an example where the intermediate layer is a multilayered prefabricated sheet, more particularly comprising a central layer 40, and two outermost layers 41, wherein the outermost layers 41 are based on a different thermoplastic material than said central layer 40.

FIG. 6 further illustrates that, in the example, hollow portions 39 or closed cells are available at the surface 30 of said outermost layer 31, wherein the shortest distance D between the center 42 of such cell and said surface 30 is less than the largest dimension of said cell and, in this case, a plurality of such cells are at least partially positioned within a distance Dm of 50 micrometer from said surface 30.

FIG. 7 illustrates some steps in a method for manufacturing a decorative panel 1. The method comprises the step of extruding a board material 43 through a die 44 having a slot nozzle 45 by means of an extruder 46. The extruded board material 43 comprises, in this case, a single layer of a, preferably filled, thermoplastic material having an outermost layer 31 that is foamed. In the example, CO₂ is injected into the part 47 linking the outlet 48 of the extruder 46 and the die 44. Alternatively said single layer may be unfoamed. The thermoplastic material may be PVC or alternatively polypropylene, polyethylene or polyethylene terephthalate.

FIG. 7 further illustrates that, in a step S3, an intermediate layer 29 is provided on the outermost layer 31. In this case, the intermediate layer 29 is a prefabricated sheet material taken from a roll 49. The prefabricated sheet material of the example is a prefabricated sheet of coPET that is thermally laminated in a stretched manner to said outermost layer 31. The thermal lamination is effected by means of at least a pair of rollers 50. It is clear that, alternatively, said intermediate layer 29 may be based on and/or may be essentially made of glycidyl methacrylate (GMA), glycidyl methyl methacrylate (GMMA), or copolymers of GMA and/or GMMA

Downstream the lamination of the intermediate layer 29, a decorative top layer 3 is provided on said intermediate layer 29, in this case by thermal lamination by means of rollers, as well, in step S4. In the example, the decorative top layer 3 comprises a thermoplastic foil 34 carrying a decorative print or motif 33, and a translucent of transparent wear layer 35.

Not represented here is that the step S4 of lamination may be followed with an embossing step, wherein a texture is provided at least in said wear layer 35, and/or be followed with a liquid application, e.g. by means of one or more rollers, of one or more transparent lacquer layers.

Further, again not represented, the extruded board material 43 which is thus treated and laminated is divided in panels, the dimensions of which about coincide with the desired final dimensions of the decorative panel 1, and further operations, such as milling operations for forming coupling parts at one or more pairs of opposite edges, may be performed in order to finish the product.

FIG. 7 illustrates that the extruder 46 comprises at least a screw 51. In the example of FIG. 8, the screw 51 comprises a transporting section 52, a compression section 53, a decompression section 54 and a mixing section 55. At the location of the mixing section 55, in this case, the screw 51 is provided with pins 56 distributed on its circumference. Alternatively the protrusions on the screw 51 at this location may be shaped differently, though preferably with interrupted protrusions, i.e. with protrusion that are discontinuous over the circumference of the mixing section 55. For example, the protrusions may be shaped as protruding cubes forming a pineapple texture, or may be available as interrupted spirals, such as interrupted spiraling fins, on the circumference, forming for example a so-called Saxton type mixer.

In the variant of FIG. 8, injection I of CO₂ is taking place at the location of said mixing section 55. Further FIG. 8 illustrates that the decompression section 54 may be provided with venting 57, or even with a vacuum, e.g. in order to evacuate abundant air or other volatile components. Preferably, in FIGS. 7 and 8, the CO₂ is added in a pulsating manner, preferably at a frequency below 1 Hz.

In the case of FIG. 7, a mixing screw may be available in the part 47 that links the extruder outlet 48 with the die 44.

Although FIGS. 7 and 8 only show one extruder screw 51, it is clear that the extruder 46 is preferably a twin screw extruder, having two complementary screws 51, each having sections as illustrated in the respective FIGS. 7 and 8.

In any case, i.e. with a single screw extruder or a twin screw extruder, or even with a multiple rotating screw extruder, the venting 55 may be performed through one or a plurality of openings 58 in the extruder barrel 59. The injection I of CO₂, or another whether or not liquefied gaseous substance, may also be performed through one or a plurality of openings 58 in the extruder barrel 59 and/or by injection I into the part 47 linking the extruder outlet 48 with the die 44. According to a special embodiment the whether or not liquefied gaseous substance is injected at at least two subsequent locations along the trajectory of the extruded or to be extruded material. Preferably a first location comprises an injection I through an opening 58 in the extruder barrel 59, preferably at the location of a mixing section 55, while, preferably, a second location comprises an injection I into the part 47 linking the extruder outlet 48 with the die 44.

FIGS. 7 and 8 further illustrate that the step of extruding S1 may be followed by a cooling operation S2. In the illustrated case, the cooling operation S2 is performed using a plurality of cooled rollers 60-61. As illustrated, the cooling operation S2 is performed by transporting the extruded board material 43 through the nip 62 formed by two pairs of rollers 60-61. These pairs of rollers 60-61 are positioned in proximity of the die opening or slot nozzle 45. The cooling operation S2 starts within a distance Dc, in this case smaller than 1 meter, from the die opening or slot nozzle 45, as measured along the trajectory of the extruded board material 43, and is, in this case, finished before said intermediate layer 29 is provided in step S3.

FIG. 9 illustrates that the extruded board material 43 of FIG. 7 is transported through a nip 62 created between two opposing surfaces 63, wherein the respective surfaces of said extruded board material 43 are distanced from said opposing surfaces 63 by means of a stream 64 of liquid or gas. Preferably a stream 64 of air is applied. Preferably said opposing surfaces 63 perform a calibrating treatment, or a levelling treatment on the respective surfaces of said extruded board material 43. The stream 64 of air may minimize the friction on the surfaces of said extruded board material 43, and minimize the energy needed for performing the treatment. In the example, said opposing surfaces 63 are flat surfaces of plates 65 facing the respective surfaces of said extruded board material 43. In accordance with FIG. 7, the extruded board material 43 is transported through said nip 62 before the application of any further layers, such as the intermediate layer 29 and the layers 34-35 comprised in the decorative top layer 3.

It is noted that the extruders 46, extruder screws 51, calibrating equipment with two opposing surfaces 63 and using a stream 64 of liquid or gas, as illustrated in the FIGS. 7 to 9 illustrate embodiments in accordance with the fourth independent aspect. Although illustrated here in combination with an intermediate layer 29 and with extruded board materials 43 comprising a foamed layer, it is clear that, in general, such intermediate layer 29 and/or such foamed layer is not necessary within the context of preferred embodiments of the fourth independent aspect.

The present invention is not limited to the preferred embodiments described here above, but such decorative panels and methods may be realized according to several variants without leaving the scope of the invention.

1-17. (canceled)

18. A decorative panel comprising at least a substrate and a decorative top layer, wherein said substrate is or comprises a board material comprising one or more layers of thermoplastic material and wherein said decorative top layer at least comprises a decorative print,
wherein an intermediate layer is present intermediate the surface of an outermost layer of said substrate or board material and said decorative print,
wherein said intermediate layer is based on and/or is essentially made of glycidyl methacrylate (GMA), glycidyl methyl methacrylate (GMMA), or copolymers of GMA and/or GMMA.

19. The decorative panel of claim 18, wherein said one or more layers of thermoplastic material are layers of filled thermoplastic material wherein the weight ratio filler: thermoplastic material is above 1:1.

20. The decorative panel of claim 18, wherein said one or more layers of thermoplastic material are layers of foamed thermoplastic material.

21. The decorative panel of claim 18, wherein said one or more layers of thermoplastic material are layers of filled poly olefinic material, in particular layers of polypropylene.

22. The decorative panel of claim 18, wherein said one or more layers of thermoplastic material are layers of polyvinyl chloride,
wherein said polyvinyl chloride is preferably unplasticized or comprises a plasticizer content of 5 phr or less.

23. The decorative panel of claim 18, wherein said intermediate layer has an average thickness of 5 micrometer or more,
wherein said average thickness is lower than the thickness of said decorative top layer.

24. The decorative panel of claim 18, wherein said decorative print comprises inks provided on a thermoplastic foil,
wherein said intermediate layer is present intermediate said substrate or board material and said thermoplastic foil,
wherein said intermediate layer is preferably directly adjacent to said thermoplastic foil,
wherein said intermediate layer is based on and/or is essentially made of glycidyl methacrylate (GMA), glycidyl methyl methacrylate (GMMA), or copolymers of GMA and/or GMMA.

25. The decorative panel of claim 24, wherein said intermediate layer is based on a thermoplastic material different from the material of said thermoplastic foil and/or said board material.

26. The decorative panel of claim 25, wherein said board material is a whether or not foamed, preferably filled, polypropylene or polyvinylchloride extruded board material.

27. A decorative panel comprising at least a substrate and a decorative top layer,
wherein said substrate is or comprises an extruded board material comprising one or more layers of thermoplastic material and wherein said decorative top layer at least comprises a decorative print,
wherein an outermost layer of said extruded board material is foamed and/or filled with hollow filler materials, and in that an intermediate layer is present intermediate the surface of said outermost layer and said decorative print,
wherein said intermediate layer is based on and/or is essentially made of glycidyl methacrylate (GMA), glycidyl methyl methacrylate (GMMA), or copolymers of GMA and/or GMMA.

28. The decorative panel of claim 27, wherein said decorative print comprises inks provided on a thermoplastic foil,
wherein said intermediate layer is present intermediate the surface of said outermost layer and said thermoplastic foil.

29. The decorative panel of claim 27, wherein said intermediate layer is directly adjacent to said thermoplastic foil, or in that said intermediate layer is separated from said thermoplastic foil exclusively by means of a glue layer.

30. The decorative panel of claim 27, wherein said intermediate layer is based on a thermoplastic material different from the material of said thermoplastic foil.

31. A method for manufacturing a decorative panel, wherein said method comprises at least the following steps:
the step of extruding a board material comprising one or more layers of thermoplastic material and wherein the outermost layer of said extruded board material is foamed or filled with hollow filler materials;
the step of providing an intermediate layer on said outermost layer;
the step of providing a decorative top layer on said intermediate layer, wherein said intermediate layer is based on and/or is essentially made of glycidyl methacrylate (GMA), glycidyl methyl methacrylate (GMMA), or copolymers of GMA and/or GMMA.

32. A decorative panel comprising at least a substrate and a decorative top layer, wherein said substrate comprises one or more layers of thermoplastic material, preferably polypropylene, polyethylene terephthalate or glycol modified polyethylene terephthalate,
wherein at least one of said one or more layers of thermoplastic material and/or said decorative top layer and/or an optional intermediate layer available between said substrate and said decorative layer, comprise one or more of
glycidyl methacrylate (GMA), glycidyl methyl methacrylate (GMMA), a copolymer of GMA and/or GMMA, for example ethylene-glycidyl methacrylate copolymer (EGMA);
ethylene acrylate, ethylene terpolymer, a copolymer of ethylene and methacrylate;
an ionomer, preferably a sodium ionomer. Preferably the ionomer is a low molecular weight ionomer;
methyl methacrylate butadiene styrene copolymer (MBS);
chlorinated polypropylene (CPP);
ethyl vinyl acetate (EVA);
butene copolymer, such as butene alfa-olefinic copolymer; and
propylene copolymer, such as propylene based alfa-olefinic copolymer.
